(19) United States
(12) Patent Application Publication
(10) Pub. No.: US 2006/0232855 A1
(43) Pub. Date: Oct. 19, 2006

(54) Bright-field light source for fluorescence observation and surgical microscope with bright-field light source

(75) Inventors: Katsushige Nakamura, Tokyo (JP); Katsuo Alzawa, Yokohama-shi (JP); Takayuki Sota, Tokyo (JP); Atsushi Nakamura, Osaka (JP)

Correspondence Address: GREENBLUM & BERNSTEIN, P.L.C., 1950 ROLAND CLARKE PLACE, RESTON, VA, 20191, US

(73) Assignee: Mitaka Kohki Co., Ltd, Tokyo (JP)

(21) Appl. No.: 11/401,843

(22) Filed: Apr. 12, 2006

(30) Foreign Application Priority Data
Apr. 15, 2005 (JP) P2005-119082

(51) Int. Cl. G02B 21/06

(52) U.S. Cl. 359/385

(57) ABSTRACT

A bright-field light source for a surgical microscope emits visible light whose spectral intensity in a wavelength at the wavelength (672 nm) of fluorescence radiated from an observation object is weaker than that of the remaining wavelength regions of the visible light. With the bright-field light source, the surgical microscope allows a clear observation of the periphery of the fluorescent object. The spectral intensity of the visible light from the bright-field light source is relatively suppressed in the wavelength region of the fluorescence radiated from the observation object. Accordingly, the visible light from the bright-field light source never bothers observation of the fluorescent object. The bright-field light source and an excitation light source such as a semiconductor laser unit are mounted on the surgical microscope without a need of additional supports.

### BACKGROUND OF THE INVENTION

1. Field of the Invention

The present invention relates to a bright-field light source for fluorescence observation and a surgical microscope having such a light source.

2. Description of Related Art

When carrying out a brain surgical operation, a photosensitive material is given to the patient. The photosensitive material collects at an affected part such as a tumor of the patient. Then, illumination of an operation room is turned off and excitation light such as a laser beam having a wavelength that can excite the photosensitive material is emitted toward the affected part. With the excitation light, the affected part radiates fluorescence when the photosensitive material collected at the affected part is excited by the excitation light. The wavelength of the radiating fluorescence is longer than that of the excitation light, and therefore, the affected part that is radiating the fluorescence is observable with a surgical microscope provided with a notch filter or a high-pass/low-pass filter that cuts the wavelength of the excitation light.

The wavelength of the excitation light must be cut through a filter because the intensity of the excitation light is excessively high to prevent the observation of the fluorescence from the affected part. In the dimmed operation room, a view field of the surgical microscope only displays the fluorescent affected part and the periphery thereof is dark and hardly observable. Accordingly, to observe the periphery of the affected part, the excitation light irradiating the affected part must be turned off and the operation room must be lighted.

### SUMMARY OF THE INVENTION

According to the above-mentioned related art, observing the dark periphery of a patient's fluorescent affected part involves bothersome work of turning off excitation light and lighting an operation room.

According to the present invention, provided is a bright-field light source that allows an operator to simultaneously observe a fluorescent affected part and the periphery thereof through a microscope, as well as a surgical microscope having such a bright-field light source.

According to a first aspect of the present invention, a bright-field light source for a surgical microscope is provided. The surgical microscope irradiates an objective part where a photosensitive material collects therein with excitation light to make the collecting photosensitive material excite and radiate fluorescence. The surgical microscope has a notch filter to cut the wavelength of the excitation light so that the objective part and the periphery thereof become observable with the surgical microscope. For such a surgical microscope, the bright-field light source illuminates the objective part and the periphery thereof with visible light whose wavelength region around the wavelength of the fluorescence from the objective part is weaker in intensity than the other wavelength regions or is cut by a filter.

A second aspect of the present invention provides a surgical microscope having an attachment on which the bright-field light source of the first aspect is mounted. The attachment is detachably attached to an observation light entrance of the surgical microscope.

### BRIEF DESCRIPTION OF THE DRAWINGS

FIG. 1 is a schematic view showing a surgical microscope according to an embodiment of the present invention;

FIG. 2 is a view showing a view field of a surgical microscope with a dark peripheral according to a related art;

FIG. 3 is a view showing a view field of a surgical microscope with a clear peripheral according to an embodiment of the present invention; and

FIG. 4 is a graph showing the spectral intensity of a white LED according to an embodiment of the present invention.

### DETAILED DESCRIPTION OF EMBODIMENTS

A bright-field light source and a surgical microscope employing such a light source according to embodiments of the present invention will be explained. The bright-field light source allows an operator to simultaneously observe a patient's phosphorescent affected part and the periphery thereof through a microscope. The microscope irradiates the affected part where a photosensitive material collects therein with excitation light to make the collected photosensitive material excite and radiate fluorescence. The microscope has a notch filter to cut in a range being the wavelength of the excitation light so that the operator can observe the phosphorescent affected part through the microscope. The bright-field light source illuminates the affected part and the periphery thereof with visible light wherein spectral intensity of the visible light in a range around the wavelength of the fluorescence from the objective part is suppressed with respect to that in other range of wavelength. Alternatively, as light radiated from light source passes through a filter attenuating in a range around the wavelength of the fluorescence from the objective part, the visible light is also provided.

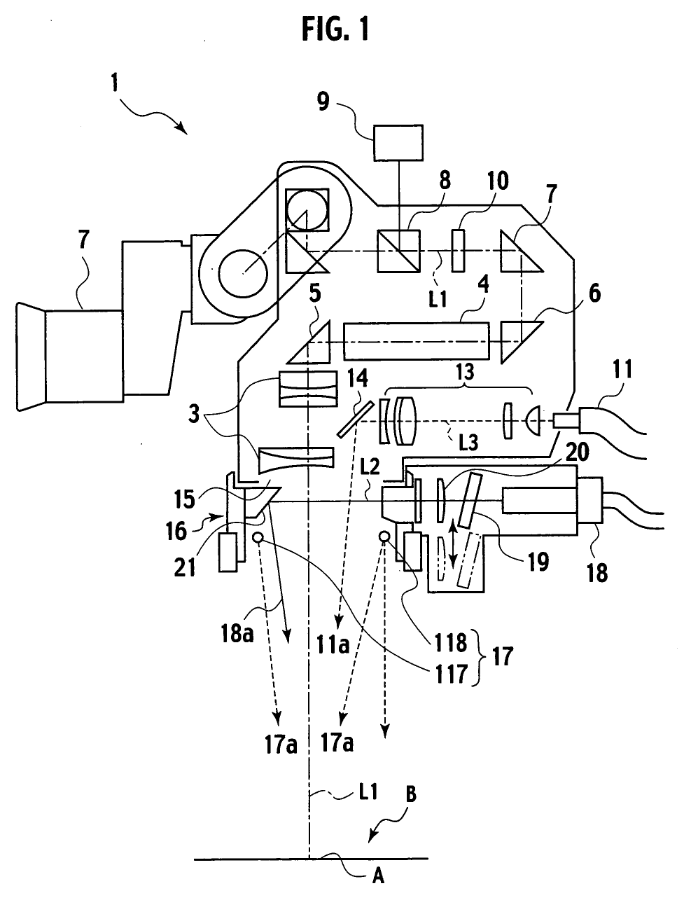

The bright-field light source and surgical microscope according to embodiments of the present invention will be explained in detail with reference to FIGS. 1 to 4.

In FIG. 1, the surgical microscope 1 according to an embodiment of the present invention is supported with an arm of a medical stand (not shown) installed in an operation room. The microscope 1 is a three-dimensional microscope having two eyepieces 2. Inside the microscope 1, a focus lens 3 and a zoom lens 4 are arranged on an optical path L1. The focus lens 3 has an optical axis that runs in parallel with the optical path L1 and is oriented toward an observation object A. The optical axis of the focus lens 3 is vertical in FIG. 1. The zoom lens 4 has an optical axis that runs along the optical path L1 and is perpendicular to the optical axis of the focus lens 3. In FIG. 1, the optical axis of the zoom lens 4 is arranged horizontally.

Light passed through the focus lens 3 is guided through a prism 5 to the zoom lens 4. The optical path L1 passes through the zoom lens 4, being bent by two prisms 6 and 7, to reach the eye pieces 2. Between the prism 7 and the eye pieces 2, a beam splitter 8 is arranged to split light. The split light is photographed by a CCD camera 9 as a two-dimensional imager. A notch filter 10 is arranged on the optical path L1 between the beam splitter 8 and the prism 7. The notch filter 10 cuts light having a wavelength of 664 nm that is the wavelength of excitation light.

Along the light path L1, the focus lens 3, prism 5 serving as a reflector, zoom lens 4, two prisms 6 and 7 serving as reflectors, and notch filter 10 are successively arranged in this order. The optical path L1 is perpendicularly bent by the reflector 5 and is further bent by the reflectors 6 and 7.

Under the zoom lens 4, an optical fiber 11 coupled with a normal light source such as a halogen lamp or a xenon lamp is introduced to the surgical microscope 1. When conducting normal observation instead of fluorescence observation, the normal light source 11 provides normal light 11a through a relay lens 13 and a mirror 14, to illuminate the affected part A. The relay lens 13 and mirror 14 are on an optical path L3.

The optical path L1 passes through an observation light entrance 15. An attachment 16 is removably attached to the observation light entrance 15. The attachment 16 has an opening for the optical path L1 passing therethrough and a white light source 17 that includes white light emitting elements 117 and 118 being arranged around the observation light entrance 15.

The white light emitting elements 117 and 118 are typically semiconductor light emitting elements such as white LEDs or organic semiconductor light emitting elements. The white light emitting elements 17 (117, 118) are arranged at different radial locations with respect to the optical path L1, to uniformly illuminate the periphery of the affected part A. It is preferable to arrange the white light emitting elements 17 on an imaginary ring whose center is on the optical path L1. On the imaginary ring, the elements 17 maybe arranged at regular interval or at predetermined positions, to illuminate the affected part A and the periphery B thereof from at least two directions. For example, two groups of white LEDs may be arranged in two arc regions, respectively, on the imaginary ring. In this case, each group contains, for example, four white LEDs arranged in the arc region that spreads for 60 degrees, for example. The arc regions of the two groups of white LEDs may be partly or wholly axially symmetrical, to cancel or reduce the shadows of irregularities on the surface of the affected part A so that the shape and color of the affected part A are clearly observable.

The intensity of light emitted from the white light source 17 including the light emitting elements 117 and 118 maybe adjustable. The light emitting elements of the white light source 17 may be selectively turned on and off. Illuminating conditions of the white light source 17 may be adjusted to clearly distinguish an image produced by fluorescence from an image produced by normal light. By selecting elements to emit light in the white light source 17, it becomes possible to illuminate the affected part A and the periphery B thereof from a specific direction or directions to clearly show the details of the affected part A with shadows.

The “white light” is not monochromatic light such as blue or red light but is visible light of a wide band covering blue to red. The white light source 17 includes the white light emitting elements 117 and 118 to emit white light except light of a specific wavelength (λ_{E}). The white light source 17 is the bright-field light source according to the present invention and is capable of making the shape and color of the affected part A clearly observable when the affected part A radiates fluorescence.

The attachment 16 is provided with a semiconductor laser unit 18 serving as an excitation light source. The semiconductor laser unit 18 emits a laser beam 18a serving as excitation light. The laser beam 18a passes through a band-pass filter 19 and a lens 20, is reflected by a mirror 21 fixed to the attachment 16, and irradiates the affected part A and the periphery B thereof. The laser beam 18a travels along an optical path L2. The band-pass filter 19 passes only light having a wavelength of λ_{E}=664 nm. The band-pass filter 19 and lens 20 are movable. When the lens 20 is moved out of the optical path L2, the laser beam 18a irradiates a narrow range of the affected part A. When the lens 20 is moved onto the optical path L2, the laser beam 18a irradiates a wide range of the affected part A.

To observe the affected part A, which may be a brain tumor of the patient, with the surgical microscope 1, a photosensitive material that collects at the affected part A is administered to the patient. An example of the photosensitive material is LASERPHYRIN (registered trade mark) or talaporfin sodium (general name). The administered talaporfin sodium selectively accumulates in cells of the affected part A. Illumination of an operation room is turned off, and the normal light source 11 of the surgical microscope 1 is also turned off. To the affected part A where the photosensitive material is accumulating, the semiconductor laser unit 18 provides the laser beam 18a of 664 nm in wavelength. At this time, the white light source 17 is turned on to provide white light beam 17a that illuminates the affected part A and the periphery B thereof.

The laser beam, i.e., excitation beam 18a excites the photosensitive material collecting at the affected part A, which emits fluorescence of 672 nm in wavelength. The fluorescent affected part A is observed and photographed with the microscope 1. The excitation beam 18a may bother the observation of the affected part A. To prevent this, the notch filter 10 can be used to suppress the spectral peak of the laser beam 18a while passing other spectral range, so that the fluorescent affected part A becomes clearly observable. The white light source 17 allows the periphery B to be clearly observed without bothering the observation of the fluorescent image of the affected part A.

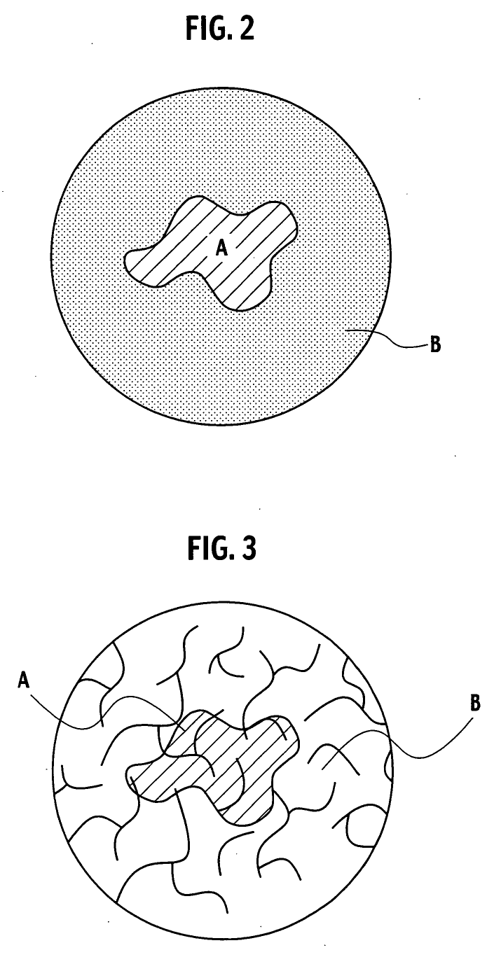

FIG. 2 is an example of a view field according to a related art showing a fluorescent affected part A. The related art has no white light 17a. Only the affected part A is observable with fluorescence radiated from the affected part A. The periphery of the affected part A is dark and is unobservable. This is because the fluorescence from the affected part A is weaker in intensity than normal illumination light that illuminates the periphery of the affected part A, and therefore, the normal illumination light must be turned off when observing the fluorescence from the affected part A. FIG. 3 is an example of a view field according to the embodiment of the present invention employing the white light source 17 of white LEDs. According to the embodiment, the periphery B thereof is clearly observable as well as the fluorescent affected part A. With the microscope 1 of the present invention, an operator can safely and easily carry out an operation.

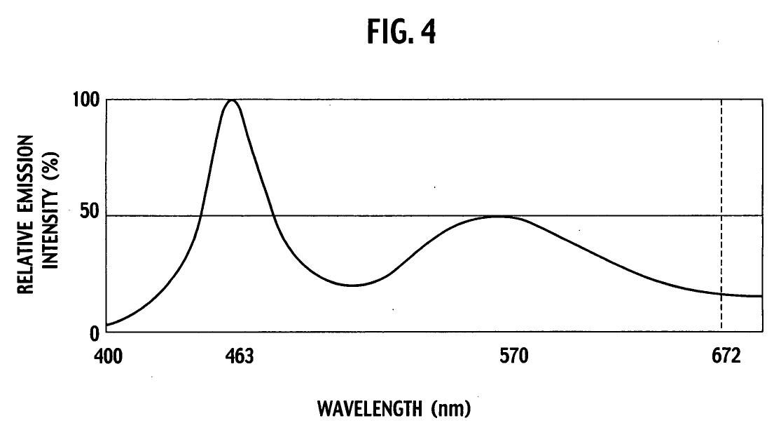

The white light source 17 according to the embodiment of the present invention can surely illuminate the periphery B of the affected part A without bothering fluorescence from the affected part A. This is because of the characteristics of the white LEDs of the white light source 17. Generally, a white LED that emits white light employs a combination of three primary color (RGB) light emitting elements, or a combination of a blue light emitting element and yellow fluorescent material. It is preferable for the present invention to employ the combination of blue light emitting element and yellow fluorescent material. The yellow fluorescent material partly absorbs blue light and excites to emit yellow light. Namely, the light from the yellow phosphor has a primary local maximum in a blue wavelength region and a secondary local maximum in a yellow wavelength region (including the wavelength of 672 nm) which is broader and lower with respect to the primary local maximum as shown in FIG. 4. A white LED of this type provides visible light which has spectral intensity at the wavelength (672 nm) of fluorescence from the affected part A being weaker than spectral intensity at other wavelengths of the visible light. Due to this, the white light 17a from the white light source 17 never bothers the observation of fluorescence from the affected part A. Namely, the white light source 17 including the white LEDs 117 and 118 is usable as a bright-field light source for observing fluorescence.

The white light source 17 according to the above-mentioned embodiment employs the characteristics of white LEDs as they are. Any other white light emitting elements may be employed as the white light source 17 with a filter configured to cut or attenuate spectral intensity in a range around the wavelength of the above-mentioned fluorescence.

The surgical microscope 1 according to the embodiment includes the attachment 16 that is removably fitted to the observation light entrance 15 of the microscope 1. The white light source 17 and the semiconductor laser unit 18 are mounted on the attachment 16. No other supports are needed for supporting the white light source 17 and the semiconductor laser unit 18 or for orienting them toward the affected part A.

When not used, the attachment 16 may be conveniently detached from the microscope 1. Once detached, the white light source 17 and the semiconductor laser unit 18 on the attachment 16 are easy to maintain, replace, or adjust. With the attachment 16 detached, the microscope 1 can be used with the normal light source 11 to conduct normal observation.

Although the embodiment mentioned above employs the white LEDs 117 and 118 as the bright-field light source 17, any other elements that emit visible light may be employed as the bright-field light source 17 with a filter that cuts the wavelength of fluorescence emitted from an observation object.

In this way, the surgical microscope according to the present invention employs a bright-field light source that provides visible light whose intensity in a wavelength region in which the wavelength of fluorescence radiated from an observation object is present is weaker than the intensities of the remaining wavelength regions of the visible light. The bright-field light source may have a filter to cut the wavelength region in which the wavelength of fluorescence radiated from an observation object is present. With such a bright-field light source, the surgical microscope of the present invention allows an operator to clearly observe the periphery of the fluorescence radiating object. Since the intensity of the visible light from the bright-field light source at the wavelength of fluorescence from an observation object is weak or cut, the visible light never bothers the observation of the fluorescent observation object. As a result, the operator can simultaneously observe a fluorescent image of the object and a visible light image of the periphery of the object because the images are clearly distinguishable from each other.

The bright-field light source is mounted on the surgical microscope without a need of additional supports. This improves convenience of use.

The bright-field light source is mounted on an attachment that is removably attached to the surgical microscope. When not used, the attachment with the bright-field light source can be detached from the microscope. This configuration realizes easy maintenance, replacement, and adjustment for the bright-field light source.

This application claims benefit of priority under 35 USC §119 to Japanese Patent Applications No. 2005-119082, filed on Apr. 15, 2005, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A bright-field light source for a surgical microscope, the surgical microscope irradiating an objective part where a photosensitive material collects with excitation light to make the collected photosensitive material excite and radiate fluorescence, and spectral intensity at the wavelength of the excitation light being suppressed to make the objective part observable with the surgical microscope, the bright-field light source comprising
a white light source configured to provide white light that illuminates the objective part and the periphery thereof, spectral intensity of the white light at a wavelength of the fluorescence being weaker than that of the white light in a range of other wavelengths.

2. The bright-field light source of claim 1, wherein the white light source comprises a white light emitting diode.

3. The bright-field light source of claim 1, wherein
the white light source comprises a plurality of white light emitting elements arranged around an observation optical path of the surgical microscope.

4. The bright-field light source of claim 1, wherein
the white light source emits visible light through a filter that cuts or attenuates spectral intensity in a range at the wavelength of the fluorescence.

5. A surgical microscope comprising the bright-field light source according to claim 1.

6. A surgical microscope comprising the bright-field light source according to claim 2.

7. A surgical microscope comprising the bright-field light source according to claim 3.

8. The surgical microscope of claim 5, wherein
the bright-field light source is detachable from the surgical microscope.

9. The surgical microscope of claim 6, wherein
the bright-field light source is detachable from the surgical microscope.

10. The surgical microscope of claim 7, wherein
the bright-field light source is detachable from the surgical microscope.

11. The surgical microscope of claim 5, wherein
the bright-field light source is mounted on an attachment that is detachably attached to an observation light entrance of the surgical microscope.

12. The surgical microscope of claim 6, wherein
the bright-field light source is mounted on an attachment that is detachably attached to an observation light entrance of the surgical microscope.

13. The surgical microscope of claim 7, wherein
the bright-field light source is mounted on an attachment that is detachably attached to an observation light entrance of the surgical microscope.

14. The surgical microscope of claim 11, wherein
the attachment includes a light source for emitting the excitation light for exciting the photosensitive material.

15. The surgical microscope of claim 12, wherein
the attachment includes a light source for emitting the excitation light for exciting the photosensitive material.

16. The surgical microscope of claim 13, wherein
the attachment includes a light source for emitting the excitation light for exciting the photosensitive material.
